(19) United States
(12) Patent Application Publication
(10) Pub. No.: US 2018/0244959 A1
(43) Pub. Date: Aug. 30, 2018

(54) DISPLAY PANEL, MANUFACTURING METHOD THEREOF AND DISPLAY DEVICE

(71) Applicants: BOE TECHNOLOGY GROUP CO., LTD., Beijing (CN); HEFEI XINSHENG OPTOELECTRONICS TECHNOLOGY CO., LTD., Anhui (CN)

(72) Inventors: Liangliang JIANG, Beijing (CN); Haiyang WANG, Beijing (CN)

(21) Appl. No.: 15/715,295

(22) Filed: Sep. 26, 2017

(30) Foreign Application Priority Data
Feb. 24, 2017 (CN) 201710104519.8

(51) Int. Cl. C09J 11/04; C03C 27/10

(52) U.S. Cl. CPC C09J 11/04; C03C 27/10

(57) ABSTRACT

A display panel, a manufacturing method thereof and a display device are provided. The display panel includes: a first substrate and a second substrate arranged opposite to each other; a display region arranged on the first substrate; a composite adhesive arranged between the first substrate and the second substrate for sealing the first substrate and the second substrate, wherein the composite adhesive includes an adhesive and a water chromic material.

### CROSS-REFERENCE TO RELATED APPLICATIONS

The present application claims priority to Chinese Patent Application No. 201710104519.8, filed Feb. 24, 2017, the entire contents of which are incorporated herein by reference.

### TECHNICAL FIELD

The embodiments of the present disclosure are related to, but not limited to flat panel display technology, more specifically, to a display panel and its manufacturing method as well as a display device.

### BACKGROUND

Flat panel display devices have been widely used in the display field due to their advantages such as thinner body, more energy efficient, no radiation, and so on. The mainstream of flat panel display devices mainly includes liquid crystal display (LCD) devices and organic light emitting display (OLED) devices.

The flat panel display device generally includes an upper substrate and a lower substrate, both of which are sealed together by an adhesive (for example, an adhesive for sealing frames) arranged on the periphery of the upper substrate and the lower substrate.

The packaging and sealing processes are important procedures during the manufacturing process of the flat panel display panel, and key factors affecting the yield and the service life of the product. During the process of testing the sealing quality of the panel, the attenuation of the performance of the adhesive is a slow process, due to which the test result can only be obtained when the panel is in an environment of high temperature and high humidity for a long time. Therefore, a simple method which can determine whether the moisture has intruded into the adhesive and indicate the degree and the path of the intrusion can not only facilitate to evaluate the package structure, material property and manufacturing process, but also improve the yield and the service life of the product.

However, there are no effective methods for monitoring the sealing quality of the panel during the manufacturing process of both LCD panels and OLED panels yet. One of the related technologies is coating a layer of humidity-sensitive film containing metallic compound salt along the inner side of the adhesive, which would change color in accordance with humidity. The metallic compound salt will turn into a hydrate after reaction with moisture and thus its color will change. Therefore, the package quality can be assessed depending on the color variations reflected by the humidity-sensitive film after it absorbs humidity. Also, one of the related technologies includes coating a moisture-sensitive layer in the space between the two sealing layers. The package quality of the OLED device can be tested by observing the color variation of the moisture-sensitive layer. The drawbacks of the above mentioned approach lie in that: first, at least two rounds of sealing layers are needed to be arranged on the periphery of the panel, which greatly increases the area of the non-effective working region, so a narrow frame design cannot be achieved; second, the sensitive layers are all independent layers and thus can only reflect the degree of the erosion by moisture in the region where they are located but cannot assess and monitor the erosion of the adhesive due to moisture; and third, no sufficient instructions and information can be brought about for the analysis on the optimization of the adhesive material, the assessment of the water resistance and the design for the panel.

### SUMMARY

One aspect of the present disclosure provides a display panel including:

a first substrate and a second substrate arranged opposite to each other;

a display region arranged on the first substrate; and

a composite adhesive arranged between the first substrate and the second substrate for sealing the first substrate and the second substrate, wherein the composite adhesive includes an adhesive and a water chromic material.

In one embodiment, the mass ratio of the water chromic material and the adhesive ranges from 0.1% to 5%.

In one embodiment, the water chromic material includes one or more of cobalt chloride, cobalt sulfate, copper sulfate and copper chloride.

In one embodiment, the display panel is an LCD display panel or an OLED display panel.

A second aspect of the present disclosure provides a method for manufacturing a display panel including:

uniformly blending a water chromic material and an adhesive with a specific mass ratio to prepare a composite adhesive;

providing a first substrate and a second substrate;

forming a display region on the first substrate;

coating the composite adhesive on a periphery of the second substrate; and

assembling the first substrate and the second substrate to form a display panel by performing a UV curing to the composite adhesive.

In one embodiment, before uniformly blending the water chromic material and the adhesive with the specific mass ratio to prepare the composite adhesive, the method further includes: drying the water chromic material sufficiently.

In one embodiment, the specific mass ratio ranges from 0.1% to 5%.

In one embodiment, the water chromic material is consisted of one or more of cobalt chloride, cobalt sulfate, copper sulfate and copper chloride.

In one embodiment, the display panel is an LCD display panel or an OLED display panel.

The third aspect of the present disclosure provides a display panel which includes the display panel described as above.

### BRIEF DESCRIPTION OF THE DRAWINGS

FIG. 1 is a schematic diagram of a process of an erosion to a sealing structure using an adhesive due to moisture in the display panel in the prior art;

FIG. 2 is a schematic diagram of a display panel according to an embodiment of the present disclosure;

FIG. 3 is a flow chart of a manufacturing process of a display panel according to an embodiment of the present disclosure;

FIG. 4 is a schematic diagram of a structure of a LCD display panel according to an embodiment of the present disclosure;

FIG. 5 is a schematic diagram of a structure of a OLED display panel according to an embodiment of the present disclosure.

### DETAILED DESCRIPTION

In order to make the objectives, technical solutions and advantages of the present disclosure more clear, embodiments of the present disclosure will be described in detail below with reference to the accompanying drawings. It is to be noted that the embodiments and features thereof in the present application may be combined in any way without conflict.

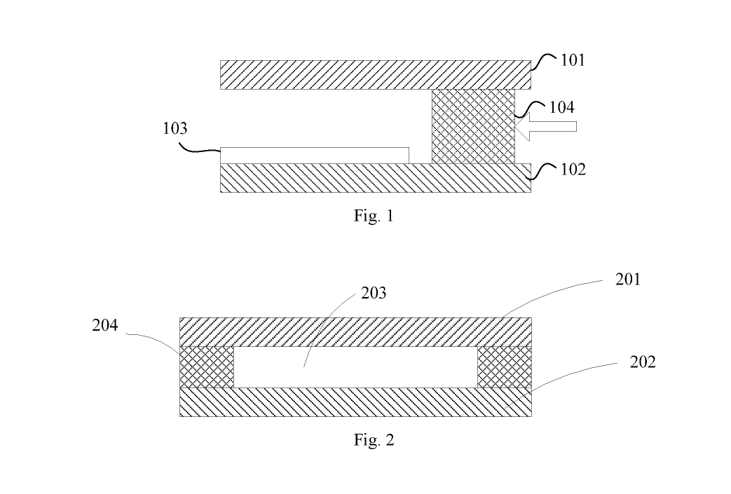

As shown in FIG. 1, for example, an LCD device has a color filter (CF) substrate 101 at one side, a TFT (thin film transistor) array substrate 102 at the other side, and a liquid crystal 103 filled between the CF substrate 101 and the TFT array substrate 102. The LCD device is sealed by an adhesive (for example, an adhesive for sealing frames) 104 on the periphery, thereby forming an enclosed and fixed structure. The adhesive 104 is needed to provide adequate sealing so as to prevent external moisture and the like from passing through the adhesive 104 and entering the inside of the panel, thereby improving the service life and the yield of the panel. The organic light emitting display (OLED) device has a substrate glass at one side and a cover glass at the other side. The organic light emitting material inside the panel emits light when the electrical current is applied to the panel directly. The substrate glass and the cover glass are also sealed and fixed by the adhesive. However, the organic light emitting material tends to react with moisture and lose its effectiveness. Hence, the OLED panel has an extremely high requirement to the packaging and sealing.

The packaging and the sealing process are important procedures during the manufacturing process of the flat panel display panel, and key factors that would impact on the yield and the service life of the product. During the process of testing the sealing quality of the panel, as shown in FIG. 1, the attenuation of the performance of the adhesive is a slow process, due to which the test result can only be obtained when the panel is in the environment with a high temperature and humidity for a long time. Therefore, a simple method which can determine whether the moisture has intruded into the adhesive and indicate the degree and the path of the intrusion can both help to assess the package structure, the material property and the manufacturing process, and improve the yield and the service life of the product.

Embodiments of the present disclosure provide a display panel and a manufacturing method thereof employing water chromic material (e.g., cobalt chloride) which presents color changes (e.g., blue→bluish→violet purple→pink) due to the variation of its composition and structure after absorbing water. This kind of water chromic material is uniformly mixed into the adhesive of the panel and then a composite adhesive having water (or moisture) sensing function is obtained. Further, the present disclosure relates to a method for testing the package quality. By adopting the composite adhesive, this method can indicate the position, the path and the degree of the erosion of the adhesive due to the moisture, thereby testing and monitoring the sealing quality of the adhesive.

FIG. 2 is a schematic diagram of a display panel according to an embodiment of the present disclosure. As shown in FIG. 2, the display panel of the present embodiment includes:

a first substrate 201 and a second substrate 202 arranged opposite to each other;

a display region 203 arranged on the first substrate 201; and

a composite adhesive 204 arranged between the first substrate 201 and the second substrate 202 for sealing the first substrate 201 and the second substrate 202, wherein the composite adhesive 204 includes an adhesive and a water chromic material.

The mass ratio of the water chromic material and the adhesive may range from 0.1% to 5%.

The mass ratio of the water chromic material and the adhesive may be 1%.

The water chromic material may include one or more of cobalt chloride, cobalt sulfate, copper sulfate and copper chloride.

In the display panel of the present embodiment, there is no need to arrange at least two rounds of sealing layers on the periphery of the panel, which significantly reduces the area of the non-effective working region in the panel, thereby achieving a design with narrow frame. Since the composite adhesive in the present embodiment has water chromic material which is distributed uniformly therein, the erosion by moisture in the region where the adhesive is located could be detected intuitively, and the erosion by moisture to the adhesive can also be assessed and monitored.

Embodiments of the present disclosure also provide a display device including the display panel described as above. The display panel may be a LCD panel or OLED panel, but it is not limited thereto.

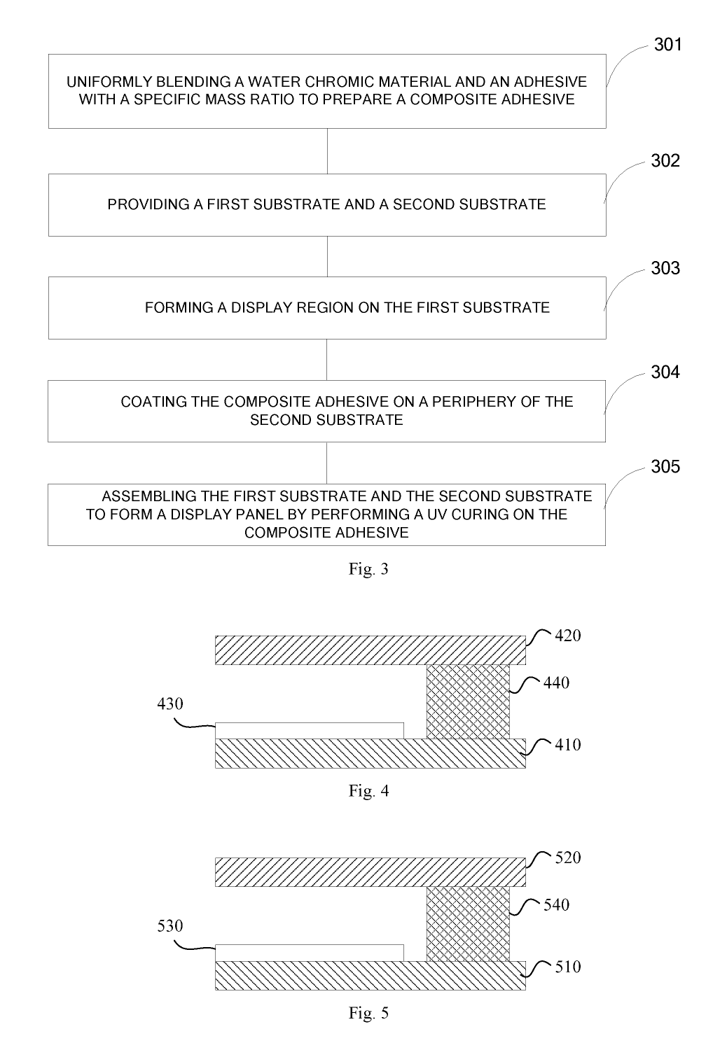

FIG. 3 is a flow chart of a manufacturing process of a display panel according to an embodiment of the present disclosure. As shown in FIG. 3, the manufacturing process of the display panel according to the present embodiment includes: uniformly blending a water chromic material and an adhesive with a specific mass ratio to prepare a composite adhesive (step 301); providing a first substrate and a second substrate (step 302); forming a display region on the first substrate (step 303); coating the composite adhesive on the periphery of the second substrate (step 304); and assembling the first substrate and the second substrate, and performing a UV curing on the composite adhesive to form a display panel (step 305).

In step 301, before uniformly blending the water chromic material and the adhesive with the specific mass ratio to prepare the composite adhesive, the method further includes: drying the water chromic material sufficiently.

The specific mass ratio is the mass ratio of the water chromic material and the adhesive, and may ranges from 0.1% to 5%.

The mass ratio of the water chromic material and the adhesive may be 1%.

The manufacturing method of the present embodiment employs a water chromic metallic compound (e.g., cobalt chloride) which presents color changes (e.g., blue→bluish violet→purple→pink) due to the variation of its composition and structure after absorbing water. This kind of water chromic material is uniformly mixed into the adhesive and then a composite adhesive having water sensing function is obtained. The display panel fabricated by the manufacturing method of the present embodiment has the following advantages: the testing and the determination to the sealing quality of the adhesive may be achieved; no extra layer structure is added and no increment of size is introduced to the frame of the panel, so a narrow frame design can be achieved; and the monitoring of the erosion of the adhesive due to moisture is used to guide both the design of the panel structure and the optimization of the adhesive material.

In the following two embodiments, the display panel and its manufacturing method according to the present disclosure are described in detail.

### Embodiment 1

The present embodiment provides an LCD panel, as shown in FIG. 4, comprising an array substrate (TFT glass) 410, a display region 430 arranged on the array substrate, a color filter substrate (CF glass) 420 and a composite adhesive 440 for sealing the above two substrates.

The composite adhesive 440 contains a water chromic agent, which is uniformly mixed and blended with an adhesive. The chromic agent changes its color when absorbing water (or moisture), and includes one or more of cobalt chloride, cobalt sulfate, copper sulfate and copper chloride.

The present embodiment further provides a method for manufacturing a LCD panel, which includes: employing cobalt chloride as the water chromic agent, which has been dried sufficiently to present blue color (step 401); providing an adhesive, uniformly blending a mixture of cobalt chloride and the adhesive with a mass ratio of 1:100 and forming a composite adhesive 440 after vacuum defoaming (step 402); providing a CF glass and coating the composite adhesive on the periphery of the CF glass (step 403); providing a TFT glass and dispensing liquid crystals on a surface of the TFT glass (step 404); aligning the CF glass and the TFT glass and assembling them in vacuum environment (step 405); and curing the composite adhesive by using UV (ultraviolet ray) at high temperature to form a LCD display panel (step 406).

The present embodiment further provides a method of testing the package quality. For example, cobalt chloride changes gradually from blue (cobalt chloride) to bluish violet (cobalt chloride.H₂O), then to purple (cobalt chloride.2H₂O), and finally to pink (cobalt chloride.6H₂O) as its water content increases. Therefore, the degree of the color variation of the adhesive indicates the variation and degree of the water content.

Since the water chromic agent is distributed uniformly in the adhesive, the position and the distance of the color variation could indicate the path and the position of the erosion of the adhesive due to moisture, which is used as guidance for improving the design and optimization of the adhesive material.

### Embodiment 2

The present embodiment provides an OLED display panel, as shown in FIG. 5, including: a substrate 510, a cover plate 520 arranged opposite to the substrate, an OLED organic display region 530 arranged on the substrate, and a composite adhesive 540 used for bonding the substrate and the cover plate together.

The composite adhesive 540 contains a water chromic agent, which is uniformly mixed and blended with the adhesive. The chromic agent changes its color after absorbing water, and includes one or more of cobalt chloride, cobalt sulfate, copper sulfate and copper chloride.

The present embodiment further provides a method for manufacturing a LCD panel, including: employing cobalt chloride as the water chromic agent, which has been dried sufficiently to present blue color (step 501); providing an adhesive, uniformly blending a mixture of cobalt chloride and the adhesive with a mass ratio of 1:100, and forming a composite adhesive after vacuum defoaming (step 502); providing a cover glass and coating the composite adhesive on the periphery of the cover glass (step 503); providing a substrate glass and forming an OLED display unit area on the substrate (step 504); aligning the cover glass and the base glass and assembling them in vacuum environment (step 505); and curing the composite adhesive by means of UV at high temperature to form a OLED display panel (step 506).

Those skilled in the art should understand that all or part of the above steps can be carried out by instructing related hardware through programs. The programs may be stored in a computer readable storage medium, such as read only memory, magnetic disk, CD, etc. All or part of the above steps in the above embodiments may also be carried out by one or more integrated circuits. Correspondingly, various modules/units in the above embodiments could be embodied in a manner of hardware or in a manner of software function modules. The present disclosure is not limited to any specific combinations of hardware and software.

The above is merely the embodiments of the present disclosure, and of course the present disclosure may have multiple other different embodiments. The person skilled in the art can make various modifications and changes in accordance with the present disclosure without departing from the spirit and substance of the present disclosure, and such modifications and changes are intended to be included in the scope of the appended claims.

What is claimed is:

1. A display panel, comprising:
a first substrate and a second substrate arranged opposite to each other;
a display region arranged on the first substrate; and
a composite adhesive arranged between the first substrate and the second substrate for sealing the first substrate and the second substrate, wherein the composite adhesive comprises an adhesive and a water chromic material.

2. The display panel of claim 1, wherein a mass ratio of the water chromic material and the adhesive ranges from 0.1% to 5%.

3. The display panel of claim 1, wherein the water chromic material comprises one or more of cobalt chloride, cobalt sulfate, copper sulfate and copper chloride.

4. The display panel of claim 2, wherein the water chromic material comprises one or more of cobalt chloride, cobalt sulfate, copper sulfate and copper chloride.

5. The display panel of claim 1, wherein the display panel is an LCD display panel or an OLED display panel.

6. A method of manufacturing a display panel, comprising:
uniformly blending a water chromic material and an adhesive with a mass ratio to prepare a composite adhesive;
providing a first substrate and a second substrate;
forming a display region on the first substrate;
coating the composite adhesive on a periphery of the second substrate; and
assembling the first substrate and the second substrate to form a display panel by performing a UV curing on the composite adhesive.

7. The method of claim 6, wherein before uniformly blending the water chromic material and the adhesive with the mass ratio to prepare the composite adhesive, the method further comprises:
drying the water chromic material sufficiently.

8. The method of claim 6, wherein the mass ratio ranges from 0.1% to 5%.

9. The method of claim 6, wherein the water chromic material comprises one or more of cobalt chloride, cobalt sulfate, copper sulfate and copper chloride.

10. The method of claim 7, wherein the water chromic material comprises one or more of cobalt chloride, cobalt sulfate, copper sulfate and copper chloride.

11. The method of claim 8, wherein the water chromic material comprises one or more of cobalt chloride, cobalt sulfate, copper sulfate and copper chloride.

12. The method of claim 6, wherein the display panel is an LCD display panel or an OLED display panel.

13. A display device comprising a display panel, wherein the display panel comprises:
a first substrate and a second substrate arranged opposite to each other;
a display region arranged on the first substrate; and
a composite adhesive arranged between the first substrate and the second substrate for sealing the first substrate and the second substrate, wherein the composite adhesive comprises an adhesive and a water chromic material.

14. The display device of claim 13, wherein the mass ratio of the water chromic material and the adhesive ranges from 0.1% to 5%.

15. The display device of claim 13, wherein the water chromic material comprises one or more of cobalt chloride, cobalt sulfate, copper sulfate and copper chloride.

16. The display device of claim 14, wherein the water chromic material comprises one or more of cobalt chloride, cobalt sulfate, copper sulfate and copper chloride.

17. The display device of claim 13, wherein the display panel is an LCD display panel or an OLED display panel.
